(19) United States
(12) Patent Application Publication
(10) Pub. No.: US 2026/0087087 A1
(43) Pub. Date: Mar. 26, 2026

(54) METHOD AND SERVER FOR PROVIDING DYNAMIC INFORMATION USABLE FOR UNTACT ORDER

(71) Applicant: ARCH SEOUL CO., Ltd., Seoul (KR)

(72) Inventors: Sae Whan PARK, Seoul (KR); Yu mi CHOI, Seoul (KR)

(73) Assignee: ARCH SEOUL CO., Ltd., Seoul (KR)

(21) Appl. No.: 19/396,610

(22) Filed: Nov. 21, 2025

Related U.S. Application Data
(63) Continuation of application No. PCT/KR2025/006070, filed on May 7, 2025.

(30) Foreign Application Priority Data
Aug. 21, 2024 (KR) 10-2024-0111908
Jun. 21, 2024 (KR) 10-2024-0081445

(51) Int. Cl. G06F 16/955; G06F 21/64; G06K 19/06

(52) U.S. Cl. CPC G06F 16/9558; G06F 21/64; G06K 19/06037

(57) ABSTRACT

A method and server for providing dynamic information for untact orders are provided. According to an embodiment of the present invention, the method for providing dynamic information for untact orders is performed by a server and may include: transmitting, at a first update period, a first update request for updating dynamic information of a first terminal; checking update status information of the first terminal; receiving the dynamic information of the first terminal from a user terminal and performing validity verification of the dynamic information; and providing internet resource address information corresponding to the dynamic information to the user terminal if the dynamic information is valid as a result of the validity verification.

### CROSS-REFERENCE TO RELATED APPLICATIONS

This application is a continuation of International Application No. PCT/KR2025/006070 filed on May 7, 2025, which claims priority to Korean Patent Application No. 10-2024-0081445 filed on June 21, 2024, and Korean Patent Application No. 10-2024-0111908 filed on August 21, 2024, the entire contents of which are herein incorporated by reference.

### FIELD OF THE INVENTION

The present invention relates to a method and server for providing dynamic information for untact orders, and more particularly, to a method and server for updating dynamic information based on a predetermined period or event and providing a temporary access path to order information of online/offline stores using the updated dynamic information.

### DESCRIPTION OF THE RELATED ART

A QR code is a means of displaying information as a two-dimensional matrix image. A QR code can store various information such as text, URI (Uniform Resource Identifier), web pages, images, videos, and sound data.

Information stored in a QR code can be obtained by photographing the QR code with a camera or reading it with an optical recognition device. With the spread of mobile devices such as smartphones and tablet computers, Internet services using QR codes are gradually increasing. For example, when a customer orders food at a restaurant, the customer can scan a QR code provided on a table with their smartphone and access a web page for ordering food through the Internet address included in the scanned QR code.

Meanwhile, as a means other than QR codes, there is NFC (Near Field Communication) that can be used to provide order information in stores. NFC is a type of wireless communication technology that can perform communication between electronic devices using short-range radio frequencies. NFC technology operates at short distances within 10 cm and has the characteristics of bidirectional communication with low power consumption and fast connection speed, and is a technology used in various fields such as mobile payment, transportation cards, access control, and data transmission.

Meanwhile, when using QR codes or NFC to provide services in stores, it is necessary to update the information transmitted through QR codes or NFC every hour, situation, or specific period. For example, when the target customer for the service changes, such as when a customer seated at a specific table in a cafe changes, the QR code information or NFC information of the table can be changed so that only the order information can be accessed through the changed information.

This is necessary to prevent unauthorized third parties who are not the target customers of the service from accessing order information, but for smooth operation of such a system, the changed information must be synchronized with the server providing order information whenever QR code information or NFC information is changed, so that the server can timely identify and block abnormal access.

### SUMMARY OF THE INVENTION

The technical problem to be solved through the present invention is to provide a dynamic information providing method and server that can enable easy untact ordering using terminals provided in stores, and can effectively block unauthorized third parties from accessing order information by periodically or non-periodically updating dynamic information (e.g., QR code or NFC information) provided by the terminal.

Another technical problem to be solved through the present invention is to provide a dynamic information providing method and server that allows dynamic information changes in terminals in stores to be linked with the server by transmitting whether the dynamic information is updated to the server, thereby enabling timely blocking of access attempts using expired dynamic information.

The technical problems of the present invention are not limited to the technical problems mentioned above, and other technical problems not mentioned will be clearly understood by those skilled in the art of the present invention from the description below.

To solve the above technical problem, a method for providing dynamic information for untact orders according to an embodiment of the present invention is performed by a server and includes: transmitting a first update request for updating dynamic information of a first terminal at a first update period; checking update status information of the first terminal; receiving the dynamic information of the first terminal from a user terminal and performing validity verification of the dynamic information; and providing internet resource address information corresponding to the dynamic information to the user terminal if the dynamic information is valid as a result of the validity verification, wherein the first update request is for causing the dynamic information to be updated from a first value to a second value, the step of performing validity verification differently determines validity of dynamic information having the first value according to the update status information, and the user terminal acquires the dynamic information from the first terminal using a predetermined method and can perform untact ordering using the provided internet resource address information.

To solve the above technical problem, a method for providing dynamic information according to an embodiment of the present invention is performed by a server and may include: (a) transmitting an update request for updating dynamic information based on a predetermined period or event; (b) receiving update completion information provided by a first terminal after transmitting the update request; (c) updating reference information stored in the server based on the update completion information; (d) receiving the dynamic information transmitted through a user terminal, wherein the user terminal acquires the dynamic information by scanning a QR code displayed on the first terminal or communicating with the first terminal in an NFC (Near Field Communication) manner; (e) verifying validity of the dynamic information by comparing the dynamic information with the reference information; and (f) providing internet resource address information corresponding to the dynamic information to the user terminal if the dynamic information is valid.

To solve the above technical problem, a server according to an embodiment of the present invention includes: a processor; a memory loading a computer program executed by the processor; and a storage storing the computer program, wherein the computer program includes instructions for performing operations of: transmitting a first update request for updating dynamic information of a first terminal at a first update period, checking update status information of the first terminal, receiving the dynamic information of the first terminal from a user terminal and performing validity verification of the dynamic information, and providing internet resource address information corresponding to the dynamic information to the user terminal if the dynamic information is valid as a result of the validity verification, wherein the first update request is for causing the dynamic information to be updated from a first value to a second value, during the validity verification, validity of dynamic information having the first value is determined differently according to the update status information, and the user terminal acquires the dynamic information from the first terminal using a predetermined method and can perform untact ordering using the provided internet resource address information.

According to the above-described embodiments of the present invention, by periodically or non-periodically updating dynamic information through linkage with a server, unauthorized third parties are effectively blocked from accessing order information, and customers can more safely and easily place untact orders in online/offline stores.

In addition, when dynamic information is updated, by transmitting this to the server so that dynamic information change information is linked with the server in real time, attempts to access order information using expired dynamic information can be blocked in a timely manner.

### BRIEF DESCRIPTION OF THE DRAWINGS

FIG. 1 is a diagram showing an entire system in which a method for providing dynamic information for untact orders is driven, according to an embodiment of the present invention.

FIG. 2 is a block diagram showing an exemplary configuration when the first terminal 200 shown in FIG. 1 is a QR code terminal.

FIG. 3 is a block diagram showing an exemplary configuration when the first terminal 200 shown in FIG. 1 is an NFC terminal.

FIG. 4 is an operation flowchart showing a method for providing order information using dynamic information according to a first embodiment of the present invention.

FIG. 5 is an operation flowchart showing a method for providing order information using dynamic information according to a second embodiment of the present invention.

FIG. 6 is an operation flowchart showing a method for providing order information using dynamic information according to a third embodiment of the present invention.

FIG. 7 is a diagram for further explaining an exemplary form of dynamic information according to an embodiment of the present invention.

FIG. 8 is a diagram for further explaining an exemplary form of an identification table.

FIG. 9 is a block diagram exemplarily showing a hardware configuration of a computing device used to implement various embodiments of the present invention.

### DETAILED DESCRIPTION OF THE INVENTION

Hereinafter, embodiments of the present invention will be described in detail with reference to the accompanying drawings. Advantages and features of the present invention and methods of achieving them will become clear with reference to embodiments described in detail below together with the accompanying drawings. In adding reference numerals to components of each drawing, it should be noted that the same components have the same numerals as much as possible even if they are displayed in different drawings. In addition, in describing the present invention, if it is determined that a detailed description of a related known configuration or function may obscure the gist of the present invention, the detailed description thereof will be omitted.

Unless otherwise defined, all terms (including technical and scientific terms) used in this specification may be used with meanings that can be commonly understood by those having ordinary knowledge in the technical field to which the present invention belongs. In addition, terms defined in commonly used dictionaries are not interpreted ideally or excessively unless clearly specifically defined. The terms used in this specification are for describing embodiments and are not intended to limit the present invention. In this specification, singular forms also include plural forms unless specifically stated otherwise in the phrase.

In addition, in describing components of the present invention, terms such as first, second, A, B, (a), (b), etc. may be used. These terms are only for distinguishing the component from other components, and the nature, order, or sequence of the component is not limited by the term. When a component is described as being "connected", "coupled", or "connected" to another component, it should be understood that the component can be directly connected or connected to the other component, but another component may also be "connected", "coupled", or "connected" between each component.

Meanwhile, in the following description, a server for providing order information using dynamic information may be abbreviated as 'server', and a method for providing order information using dynamic information may be abbreviated as 'order information providing method'.

Hereinafter, a method for providing order information using dynamic information according to an embodiment of the present invention will be described.

The method for providing order information using dynamic information according to an embodiment of the present invention relates to technology for providing a temporary access path to order information for stores such as shops using dynamic information that is updated according to time or specific events.

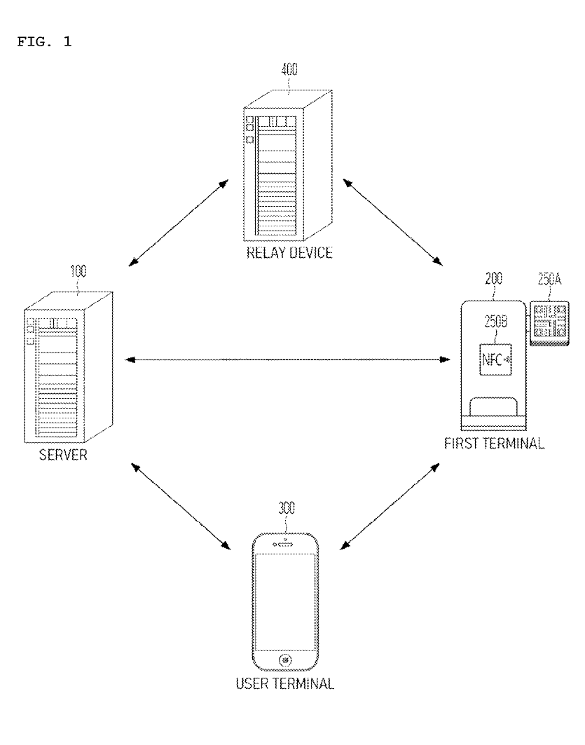

FIG. 1 is a diagram showing an entire system in which a method for providing order information using dynamic information is driven, according to an embodiment of the present invention.

Referring to FIG. 1, the entire system may include a server 100, a first terminal 200, a user terminal 300, and a relay device 400. In addition, each device constituting the system may be connected through a wired or wireless communication network to exchange data.

Here, the first terminal 200 is a terminal that provides dynamic information to the user terminal 300, and may be, for example, a terminal that provides dynamic information in the form of a QR code image or NFC information. The first terminal 200 may be referred to as a 'dynamic information providing terminal' in the sense that it provides dynamic information to the user terminal. Alternatively, the first terminal 200 may also be referred to as an 'ordering terminal' or 'order terminal' in the sense that it is necessary when the user places an order. Alternatively, the first terminal 200 may be referred to as a 'QR code terminal' when providing dynamic information as a QR code image, and may be referred to as an 'NFC terminal' when providing dynamic information in the form of NFC information.

According to an embodiment of the present invention, the server 100 transmits a dynamic information update request based on a certain period or event, and the first terminal 200 may update its own dynamic information based on this and provide update completion information to the server 100. When the server 100 receives the update completion information, it synchronizes the dynamic information of the first terminal 200 and the reference information of the server 100 by updating the reference information stored in itself. Thereafter, the user terminal 300 scans the QR code of the first terminal 200 to extract dynamic information therefrom, or receives dynamic information from the first terminal 200 in an NFC manner, acquires dynamic information, accesses the server 100 using the acquired dynamic information, receives internet resource address information from the server 100, accesses the internet resource address information, and places an order for a service.

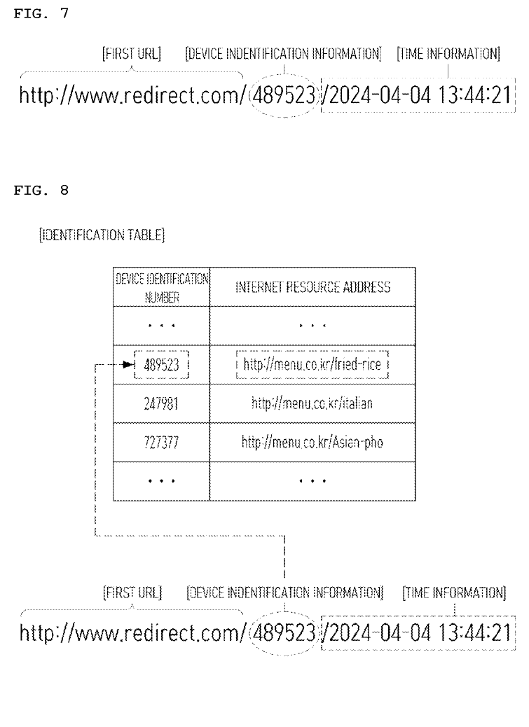

Meanwhile, the dynamic information may be information including a first Uniform Resource Locator (URL) for accessing the server 100 and device identification information of the first terminal 200. For example, as shown in FIG. 7, the dynamic information may be composed of information combining the first URL and device identification information. Here, "http://www.redirect.com" may correspond to the first URL, and "489523" may correspond to the device identification information.

Meanwhile, as an optional embodiment, time information corresponding to a time value corresponding to the dynamic information may be further included, and the time information may be a time when the dynamic information is updated, a time when a QR code including the dynamic information is generated or displayed, a time when NFC information including the dynamic information is transmitted to the user terminal, or may correspond to a representative time value of the dynamic information set by the server 100 or the first terminal 200.

Meanwhile, although FIG. 7 shows the time information as a timestamp format value in which year, month, day, hour, minute, second, etc. are displayed, such as '2024-04-04 13:44:21', the scope of the present invention is not limited thereto, and the time information may have values in various formats. For example, the time information may be a value in a format indicating a serial number or order, such as '000001' or '000002', a value in a form of an encrypted time value, such as '1R9S-mySqgVYwR-zLRJjBA', or a hashed time value, such as 'MNBUQU', in addition to a timestamp format value.

In addition, internet resource address information may be information including an address on an internet network of an internet resource device 1000 that provides order information to the user terminal 300 and receives and processes an order request from the user terminal 300. For example, this may correspond to an address on an internet network of a homepage or order page operated by a service provider.

Meanwhile, the relay device 400 is an optional configuration of this system and may mediate communication between the server 100 and the first terminal 200. For example, the dynamic information update request transmitted by the server 100 may not be transmitted directly to the first terminal 200, but may be transmitted to the relay device 400 first and then transmitted to the first terminal 200 via the relay device 400. Alternatively, the update completion information provided after the first terminal 200 updates the dynamic information may not be transmitted directly to the server 100 but may be transmitted to the relay device 400 and then transmitted to the server 100 via the relay device 400.

The relay device 400 may be, for example, a router or other data relay means that mediates data communication with the server 100 for a plurality of first terminals 200 installed in one store.

Describing each configuration shown in FIG. 1 in more detail, the server 100 according to an embodiment of the present invention transmits an update request for dynamic information based on a predetermined period or event, and may receive update completion information provided by the first terminal 200 in response to the update request, and the server 100 may update reference information stored in the server 100 based on the update completion information.

In addition, the server 100 may receive dynamic information from the user terminal 300, compare the dynamic information with the reference information to verify the validity of the dynamic information, and if the dynamic information is valid, provide internet resource address information corresponding to the dynamic information to the user terminal 300.

At this time, the validity verification of the dynamic information may determine that the dynamic information is valid if the dynamic information transmitted by the user terminal 300 corresponds to the reference information stored in the server 100 (for example, if the values of the dynamic information and the reference information match each other), and otherwise determine that the dynamic information is not valid.

Next, the first terminal 200 according to an embodiment of the present invention may correspond to a terminal for providing dynamic information to the user terminal 300.

Specifically, the first terminal 200 may receive an update request for dynamic information from the server 100, provide update completion information to the server 100 in response thereto, and transmit the updated dynamic information to the user terminal 300 in the form of a QR code or NFC information.

In one embodiment, the first terminal 200 is a QR code terminal that displays a QR code through a display device, and the display device may be a device including any one of Liquid Crystal Display, Light Emitting Diode, Organic Light Emitting Diodes, Active Matrix Organic Light Emitting Diodes, Electronic Shelf Label, E-Paper, E-Ink Display, hologram display, Quantum Dot Display, and Digital Light Processing display.

Alternatively, in one embodiment, the first terminal 200 may be an NFC terminal equipped with a communication module capable of performing data communication according to an NFC communication protocol with an external terminal.

The first terminal 200 is installed at a place providing services to users and may be a terminal that provides connection information necessary for the user to access the server 100 in order to obtain order information for services. For example, a user may acquire dynamic information from the first terminal 200 using their user terminal 300, access the server 100 using the acquired dynamic information, receive address information of an internet resource device (e.g., a store server providing an order page) from the server 100, access the internet resource device through this, inquire order information such as menu information, price information, and order information, and transmit an order request for desired products, services, etc.

The user terminal 300 is a terminal possessed by a user using the service and may be a terminal equipped with a data communication function with the outside. The user terminal 300 accesses the server 100 based on the dynamic information provided by the first terminal 200, receives internet resource address information from the server 100, and places an order for a product or service.

In one embodiment, a series of operations in which the user terminal 300 places an order for a product or service using dynamic information may be performed through an application installed in the user terminal 300. At this time, the application may be an application built into the user terminal 300 or an application downloaded from an application distribution server and installed in the user terminal 300.

In one embodiment, the user terminal 300 is a computing device capable of communicating with the server 100, and may be, for example, any one of a smartphone, mobile phone, navigation, computer, laptop, digital broadcasting terminal, Personal Digital Assistants(PDA), Portable Multimedia Player(PMP), and/or tablet PC, but is not limited thereto. For example, any device among terminal devices having a data communication function may be the user terminal 300.

The relay device 400 may be a terminal that relays between the server 100 and the first terminal 200. The relay device 400 may be a device that mediates data communication with the server 100 for a plurality of first terminals 200 installed within a certain range of geographical location. For example, when a request or data is transmitted from the server 100 to each first terminal 200, it may be transmitted via the relay device 400. Conversely, when a request or data is transmitted from the first terminal 200 to the server 100, it may also be transmitted via the relay device 400.

However, the relay device 400 is an optional configuration and may be omitted. When the relay device 400 is omitted, the server 100 and the first terminal 200 may directly communicate with each other to exchange requests or data.

Although not shown in the drawings, the system may further include an internet resource device 1000.

The internet resource device may correspond to a device accessed by the user terminal 300 through internet resource address information provided by the server 100. When the user terminal 300 accesses, the internet resource device may provide order information for services to the user terminal 200 or process an order request transmitted from the user terminal 200.

Each component (100, 200, 300, 400) shown in FIG. 1 may be interconnected through a communication network. The communication network may encompass, for example, wired networks such as Local Area Networks(LANs), Wide Area Networks(WANs), Metropolitan Area Networks(MANs), Integrated Service Digital Networks(ISDNs), or wireless networks such as wireless LANs, CDMA, Bluetooth, satellite communications, but the scope of the present invention is not limited thereto.

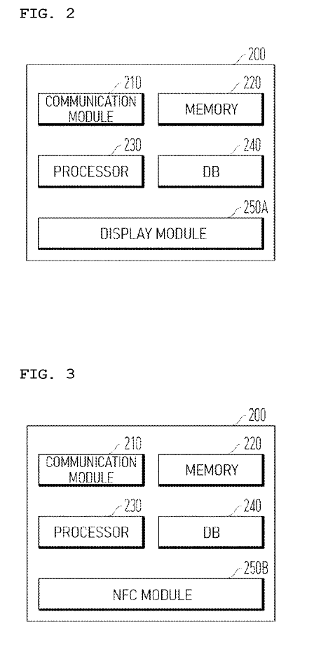

FIG. 2 is a block diagram showing an exemplary configuration when the first terminal 200 shown in FIG. 1 is a QR code terminal.

Referring to FIG. 2, the first terminal 200 according to an embodiment of the present invention may include a communication module 210, a memory 220, a processor 230, a database 240, and a display module 250A.

The communication module 210 provides a communication interface necessary to provide transmission and reception signals with external devices in the form of packet data in conjunction with a communication network. The communication module 110 may be a device including hardware and software necessary to transmit and receive signals such as control signals or data signals through wired or wireless connections with other network devices.

The memory 220 stores programs for generating, storing, and updating dynamic information or generating, storing, and displaying QR codes including dynamic information. In addition, it performs a function of temporarily or permanently storing data processed by the processor 230. Here, the memory 220 may include magnetic storage media or flash storage media, but the scope of the present invention is not limited thereto.

The processor 230 is a type of central processing unit that processes overall operations and control operations of the first terminal 200. The processor 230 may include any type of semiconductor processing device capable of processing data. The processor 230 may mean, for example, a data processing device embedded in hardware having physically structured circuits to perform functions expressed by codes or instructions included in a program. As an example of such a data processing device embedded in hardware, a microprocessor, central processing unit (CPU), processor core, multiprocessor, application-specific integrated circuit (ASIC), field programmable gate array (FPGA), and the like may be included, but the scope of the present invention is not limited thereto.

The database 240 provides non-transitory storage means for the first terminal 200. For example, data such as dynamic information or QR codes may be stored in the database 240.

The display module 250A is a module that externally displays QR codes including dynamic information, and may include various information display means such as Liquid Crystal Display (LCD), Light Emitting Diode (LED), Organic Light Emitting Diodes (OLED), Active Matrix Organic Light Emitting Diodes (AMOLED), Electronic Shelf Label (ESL), E-Paper, E-Ink Display, hologram display, Quantum Dot Display, or Digital Light Processing(DLP) display.

FIG. 3 is a block diagram showing an exemplary configuration when the first terminal 200 is an NFC terminal as another example of the first terminal 200 shown in FIG. 1. The configuration shown in FIG. 3 is mostly identical to the configuration shown in FIG. 2, except that it includes an NFC module 250B. Accordingly, descriptions of other components except the NFC module 250B will be omitted to avoid redundancy.

The NFC module 250B is a component that provides dynamic information to an external device (e.g., user terminal) in the form of NFC information, and may include, for example, one or more NFC tags configured to communicate with other terminal devices or servers through NFC standards. The NFC tag transmits NFC information including dynamic information to the external device when the external device approaches close to the NFC module 250B. Specifically, when the external device comes sufficiently close to the NFC module 250B within a predetermined distance, an NFC communication channel is established between the external device and the NFC module 250B using communication standards such as ISO/IEC 14443, Felica, or MIFARE, and NFC data transmission is performed through this channel. Since specific details of NFC data transmission technology using NFC communication channels are widely known in the art, description thereof will be omitted here.

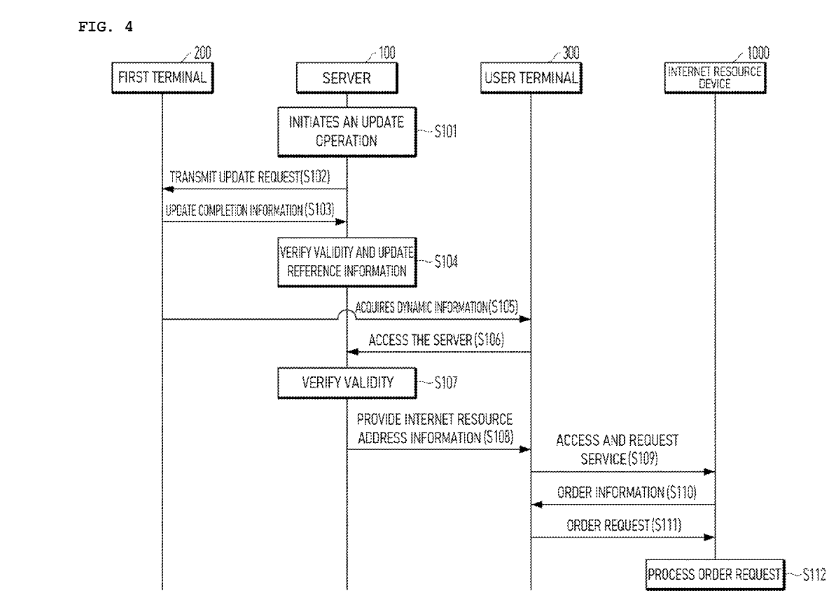

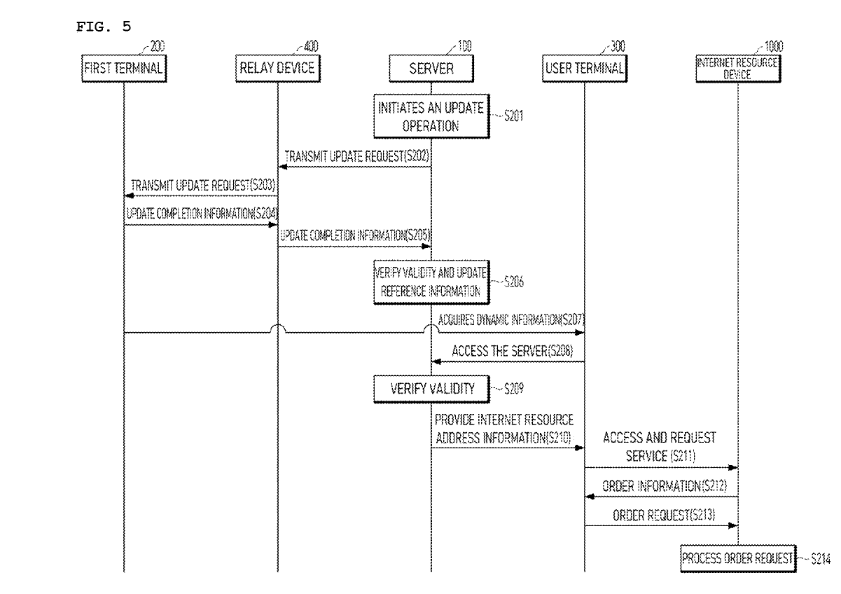

FIG. 4 is an operational flowchart illustrating a method for providing order information using dynamic information according to a first embodiment of the present invention. The first embodiment of the present invention shown in FIG. 4 illustrates the operation process of the system when the relay device 400 is omitted.

Describing the system operation method with reference to the drawings, the server 100 initiates an update operation for dynamic information based on a predetermined cycle or event (S101), and accordingly, the server 100 may transmit an update request for dynamic information to the first terminal 200 (S102).

At this time, the event may include an automatically generated dynamic information update initiation request according to a predetermined condition or an update initiation request according to user input.

For example, a time period for dynamic information update may be set in the server 100, and whenever each time period arrives, the server 100 may transmit an update request for dynamic information to the first terminal 200. Alternatively, when an administrator or service provider determines that update of dynamic information is necessary, the administrator or service provider may input a user input requesting dynamic information update to the server 100, and the server 100 may accordingly transmit an update request for dynamic information to the first terminal 200.

In one embodiment, when the server 100 transmits the update request, it may further transmit change information together therewith. Alternatively, the server 100 may transmit only the update request without transmitting change information.

At this time, the change information may include QR code image, URL information, or parameter information. When change information is transmitted together with the update request, the first terminal 200 may update the dynamic information or QR code such that the dynamic information updated during dynamic information update has a value corresponding to the transmitted change information.

For example, when a QR code image is transmitted as change information, the first terminal 200 may update the QR code (or dynamic information included therein) by replacing the existing QR code image with the transmitted QR code image.

Alternatively, when parameter information (for example, '00010') is transmitted as change information, the first terminal 200 may update its dynamic information or QR code by generating dynamic information including the transmitted parameter information and then generating a QR code image therefor.

Meanwhile, when parameter information is transmitted as change information, the first terminal 200 may generate a new combination parameter based on the parameter information and other information, and then update the dynamic information or QR code to have a value corresponding to the combination parameter.

At this time, the other information is an internal parameter of the first terminal 200, and for example, the battery remaining amount of the first terminal 200, the MAC address of the first terminal 200, or the product serial number of the first terminal 200 may be the other information.

As a more specific example, when '0010' is transmitted as parameter information and the battery remaining amount of the first terminal 200 is 51%, the first terminal 200 may generate a combination parameter '001051' by combining the two values, and update the dynamic information or QR code by generating new dynamic information to include the generated combination parameter value '001051'.

Meanwhile, although generating a combination parameter by simply combining the transmitted parameter information and the internal parameter has been exemplified here, the scope of the present invention is not limited thereto. For example, in addition to simply combining the two values, the combination parameter may be generated in various ways, such as generating an encrypted value after combining the two values as the combination parameter, generating a hashed value after combining the two values as the combination parameter, or extracting some character strings from the two values and then generating a combined value as the combination parameter.

On the other hand, when only the update request is transmitted without transmission of change information, the first terminal 200 may acquire change information by itself according to a predetermined logic in response to the update request, and update the dynamic information to have a value corresponding to the acquired change information.

Here, the predetermined logic may include logic for generating a new QR code or dynamic information according to an algorithm embedded in the first terminal 200, logic for selecting any one from a plurality of pre-stored QR codes or dynamic information, logic for acquiring time information corresponding to the current time point based on an embedded timer, and the like. At this time, the generated, selected, or acquired QR code, dynamic information, or time information corresponds to the change information acquired by the first terminal 200 itself as described above.

When the first terminal 200 completes the update of dynamic information, it provides update completion information to the server 100 (S103), and the server 100 determines whether the update of dynamic information succeeded in the first terminal 200 based on the update completion information (S104).

For example, if the update completion information includes a message indicating update success, the server 100 may determine that the update of dynamic information succeeded. On the other hand, if the update completion information includes a message indicating update failure or other error messages, the server 100 may determine that the update of dynamic information failed.

When the update of dynamic information succeeds, the server 100 updates the reference information to have a value corresponding to the updated dynamic information. Here, the reference information is information storing a value that the server 100 believes to be currently valid dynamic information, and when dynamic information is received from the user terminal 300 later, the server 100 compares the received dynamic information with the reference information to determine the validity of the corresponding dynamic information.

When the reference information is updated, the reference information before update is expired, and the server 100 rejects a request to access with dynamic information having a value corresponding to (or matching) the expired reference information by determining it as an invalid request.

Meanwhile, when the update of dynamic information fails, the server 100 retransmits the update request for dynamic information to the first terminal 200.

Meanwhile, in one embodiment, the update completion information transmitted by the first terminal 200 may include the updated dynamic information. In this case, when receiving the update completion information, the server 100 may update the reference information after reviewing the validity of the dynamic information included therein (S104).

For example, when the server 100 previously transmitted change information together when transmitting the update request for dynamic information, the server 100 may compare the dynamic information in the update completion information with the previously transmitted change information, and then confirm whether the dynamic information was correctly updated to a value corresponding to the change information.

If the dynamic information was correctly updated to a value corresponding to the change information, the server 100 may regard the update as successfully completed and update the reference information to have a value corresponding to the updated dynamic information.

On the other hand, if the dynamic information was not correctly updated to a value corresponding to the change information, the server 100 may regard the update as failed and retransmit the update request for dynamic information to the first terminal 200.

Next, the user terminal 300 acquires dynamic information from the first terminal 200 by scanning the QR code displayed on the first terminal 200 or communicating with the first terminal 200 through Near Field Communication (NFC) (S105), and may access the server 100 through the dynamic information (S106).

The server 100 receives the dynamic information transmitted by the user terminal 300 and verifies the validity of the received dynamic information (S107).

The validity verification of dynamic information may be performed by comparing the received dynamic information with the reference information of the server 100, and determining that the dynamic information is valid if the dynamic information has a value corresponding to (e.g., matching) the reference information, and otherwise determining it as invalid.

If the dynamic information received from the user terminal 300 is invalid as a result of validity verification, the server 100 may block access of the user terminal 300.

If the dynamic information received from the user terminal 300 is valid as a result of validity verification, the server 100 may provide internet resource address information corresponding to the received dynamic information to the user terminal 300 (S108).

Meanwhile, in one embodiment, in step S107, the server 100 may additionally verify the validity of the dynamic information based on time information associated with the dynamic information. Here, the time information may include a time value extracted from parameters included in the dynamic information, or a time value calculated based on the time point at which the server 100 received the dynamic information.

To additionally verify the validity of dynamic information based on time information, the server 100 may set a valid time interval corresponding to the currently valid reference information.

In one embodiment, the valid time information may be a predetermined time interval (e.g., 1 hour, 1 day, 1 week, or 1 month) set based on the time point when the reference information was updated.

When the valid time interval is set, the server 100 may perform a two-stage validity verification procedure to verify the dynamic information transmitted by the user terminal 300.

The first stage of validity verification procedure is the same procedure as described above, which is a procedure for verifying whether the values correspond to each other by comparing the dynamic information with the reference information. If the values do not correspond to each other, the dynamic information is regarded as invalid and the server 100 blocks access of the user terminal 300. If the values correspond to each other, the procedure proceeds to the second stage of validity verification procedure.

The second stage of validity verification procedure is a procedure for verifying time information associated with the dynamic information, which extracts time information associated with the dynamic information and verifies whether the extracted time information is included in the valid time interval corresponding to the reference information. If the extracted time information is outside the valid time interval, the dynamic information is regarded as invalid and the server 100 blocks access of the user terminal 300. If the extracted time information is included in the valid time interval, the dynamic information is regarded as valid and the server 100 provides internet resource address information corresponding to the dynamic information to the user terminal 300.

According to this embodiment, it is possible to effectively block attempts to access the server 100 using fake dynamic information created by combining the first URL and device identification information obtained through a chance route with a time value at an arbitrary time point (e.g., distant future).

Meanwhile, to provide internet resource address information, the server 100 may extract device identification information from the received dynamic information, refer to a predetermined identification table to inquire internet resource address information corresponding to the device identification information, and then provide it to the user terminal 300. An exemplary form of the identification table is shown in FIG. 8. Referring to FIG. 8, the server 100 may search for a row where a value identical to the device identification number extracted from the dynamic information is located from the device identification number field of the identification table, inquire the internet resource address information from the searched row, and then provide it to the user terminal 300.

Here, the internet resource address information includes an address on the internet network of the internet resource device 1000 that provides order information to the user terminal 300 and processes an order request of the user terminal 300, and may include a homepage and order page operated by a store where the user terminal 300 wishes to place an order.

For example, assuming that user terminal A 300 is located at store X and attempts to place an order, the server 100 does not receive location information of user terminal A 300 and thus cannot know whether the terminal is attempting to order at store X.

However, since the server 100 can know from which first terminal 200 the received dynamic information originated through the device identification information, it can accurately identify the order page URL (or internet resource address information) of the store operating the corresponding first terminal 200 and provide it to the user terminal 300.

When the user terminal 300 receives the internet resource address information from the server 100, the user terminal 300 accesses the internet resource device 1000 through the provided internet resource address information to request a service (S109), and can receive necessary order information (S110).

Then, an order request is transmitted from the user terminal 300 to the internet resource device 1000 (S111), and this embodiment ends with the internet resource device 1000 processing the order request (S112).

FIG. 5 is an operational flowchart illustrating a method for providing order information using dynamic information according to a second embodiment of the present invention. The second embodiment of the present invention shown in FIG. 5 illustrates the operation process of the system when the relay device 400 is included.

Comparing the embodiment of FIG. 5 with the embodiment of FIG. 4, except that when the server 100 transmits an update request for dynamic information, the update request is transmitted to the first terminal 200 via the relay device 400 (S202, S203), and when the first terminal 200 provides update completion information after completing the dynamic information update, the update completion information is transmitted to the server 100 via the relay device 400 (S204, S205), the remainder is substantially the same as the embodiment of FIG. 4.

Therefore, to avoid redundancy in description, detailed descriptions of each step (S201 to S214) will be omitted. The parts whose descriptions are omitted here can be understood as being substantially the same as those described in FIG. 4.

Meanwhile, when the server 100 requests dynamic information update for a plurality of first terminals, some first terminals successfully update dynamic information in response to the server 100's request, but some first terminals may not. For example, there may be cases where the server 100's update request fails to be delivered to the first terminal due to a temporary communication failure, or where the update request is well delivered but dynamic information fails to be updated due to an operational error inside the first terminal.

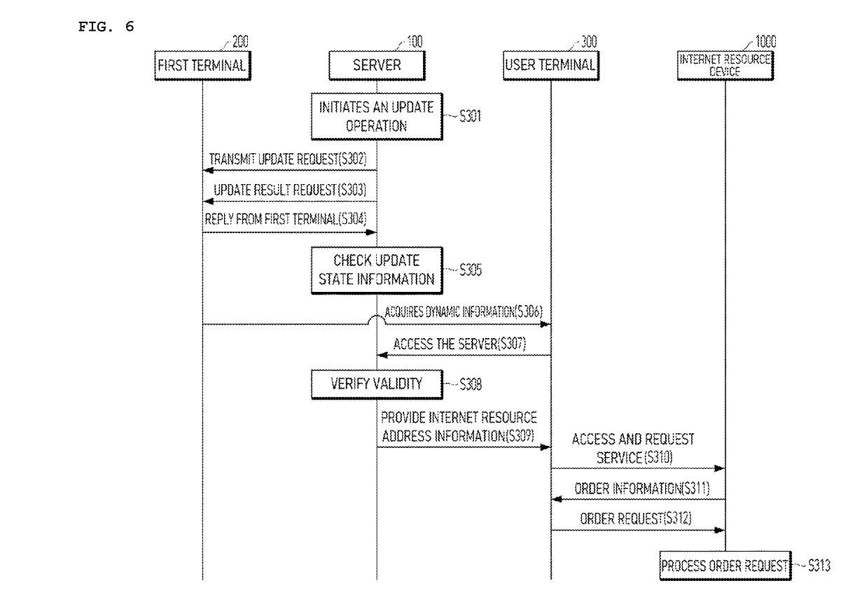

In this case, a first terminal that normally updated dynamic information and a first terminal that did not coexist, and from the perspective of operating the server 100, if it is a correct order using the first terminal in the store, it is desirable to regard and process it as a normal order even if the update did not succeed. A third embodiment of the present invention applicable to such cases will be described with reference to FIG. 6.

FIG. 6 illustrates a method for regarding and processing as a normal order even if the dynamic information update of the first terminal 200 did not succeed. In this embodiment, detailed descriptions will be omitted to avoid redundancy for content substantially the same as the previous embodiments.

Referring to FIG. 6, the server 100 may initiate an update operation for dynamic information based on a predetermined cycle (S301). Accordingly, it may transmit a first update request for updating dynamic information to the first terminal 200 in a first update cycle (S302).

Here, the first update request is for causing the dynamic information of the first terminal 200 to be updated from a first value to a second value, and the first update request may be transmitted alone or together with change information. At this time, the change information may include QR code image, URL information, or parameter information. When the update request and change information are transmitted together, the first terminal 200 may update the dynamic information or QR code such that the dynamic information updated during dynamic information update has a value corresponding to the change information.

In response to the first update request, if the first terminal 200 successfully completes the update, the dynamic information of the first terminal 200 will have a second value. Otherwise, the dynamic information of the first terminal 200 will have a first value the same as before the update.

After the server 100 requests the update of dynamic information from the first terminal 200, the server 100 confirms update status information of each first terminal 200 (S303 to S305).

To this end, first, the server 100 transmits an update result request for confirming whether the update succeeded to the first terminal 200 (S303). In this embodiment, unlike the previous embodiments, the first terminal 200 does not transmit update completion information by itself, but replies whether the update is completed in response to the server 100's update result request. This method may be more advantageous in managing overall network traffic and data processing load in a situation where the number of first terminals 200 managed by the server 100 greatly increases.

The first terminal 200 replies whether the update is completed in response to the server 100's update result request (S304).

The server 100 may confirm and store the update status information of the first terminal 200 according to the reply of the first terminal 200 (S305).

In one embodiment, the update status information that the server 100 confirms and stores may include SUCCESS, FAIL, PROCESSING, and/or TIME OUT. Here, SUCCESS means that the dynamic information update of the first terminal 200 succeeded, FAIL means that the dynamic information update of the first terminal 200 failed, PROCESSING means that the dynamic information update of the first terminal 200 is being processed and success or failure has not yet been determined, and TIME OUT means that a reply on whether the update is completed was not received from the first terminal 200 within a predetermined time.

Meanwhile, in the update status information, PROCESSING and/or TIME OUT may be regarded as the same as FAIL.

For example, when the update is not completed and continuously replies 'PROCESSING', the dynamic information of the corresponding first terminal 200 will be in a state before update, so it can be regarded as the same as 'FAIL'. In addition, when a reply on whether the update is completed is not received due to a failure on the communication network or a device abnormality of the first terminal 200, the dynamic information update of the actual first terminal 200 may have succeeded or failed, but since the server 100 cannot know its accurate state, it can be regarded as the same as 'FAIL'.

In one embodiment, even when the dynamic information of the first terminal 200 is set to be periodically updated, the server 100 may selectively transmit an update request for periodic update of dynamic information according to the update status information of the first terminal 200.

For example, assume that in a first update cycle, the server 100 sent a first update request for updating dynamic information to the first terminal 200, and then the server 100 confirmed the update status information of the first terminal 200.

Thereafter, in a subsequent second update cycle, when transmitting a second update request for periodic dynamic information update, the second update request is transmitted only to the first terminal whose update status information is SUCCESS, and the second update request is not transmitted to the first terminal whose update status information is a value other than SUCCESS (for example, FAIL, PROCESSING, or TIME OUT).

This is because, in the case of a terminal whose update is not SUCCESS, even if the second update request is transmitted, there is a high possibility that the update will fail again for the same reason in a state where the cause of the previous dynamic information update failure is not removed, and even if the subsequent update succeeds in a state where the previous update failed, there is uncertainty about whether it was updated to an accurate value, which may cause problems in continuous history management.

Therefore, when transmitting the subsequent second update request, the update status information is confirmed and the second update request is selectively transmitted only to the first terminal that is SUCCESS, and a new update request is not transmitted to the first terminal whose update status information is not SUCCESS until the cause of the previous update failure is removed.

Meanwhile, in one embodiment, when the update status information of the first terminal is not SUCCESS, the server 100 may send an alarm to an administrator terminal (not shown) of the corresponding first terminal. Then, after the administrator confirms the alarm and removes the cause of the dynamic information update failure, the server 100 receives a processing result therefor, changes the update status information of the corresponding first terminal to SUCCESS, and may resume periodic dynamic information update for the corresponding terminal.

Meanwhile, after confirmation of the update status information of the first terminal 200 is completed, for untact order, the user terminal 300 may acquire dynamic information from the first terminal 200 (S306).

For example, the user terminal 300 may acquire dynamic information from the first terminal 200 by scanning a screen or image (for example, QR code) displayed on the first terminal 200, or communicating with the first terminal 200 through NFC manner.

Then, the user terminal 300 accesses the server 100 using the acquired dynamic information, and transmits a protocol request including the dynamic information to the server 100 (S307).

The server 100 receives the dynamic information of the first terminal 200 from the user terminal 300, and performs validity verification on the received dynamic information (S308).

In one embodiment, during validity verification of dynamic information, the validity when the dynamic information has a first value may be judged differently according to the update status information of the first terminal 200.

For example, if the update status information of the first terminal 200 is SUCCESS, the dynamic information update according to the previous first update request succeeded, and the dynamic information of the first terminal 200 will have a second value. In this case, if the received dynamic information has a first value, this is not a request using the current first terminal 200, so the request to access with the corresponding dynamic information is regarded as an abnormal request and rejected.

Therefore, during validity verification, if the update status information is SUCCESS, dynamic information having a first value is determined to be invalid, and dynamic information having a second value is determined to be valid.

On the other hand, when the update status information of the first terminal 200 is a value other than SUCCESS (for example, FAIL, PROCESSING, or TIME OUT), there are two possibilities here.

The first is when the dynamic information update according to the first update request failed. In this case, the dynamic information of the first terminal 200 will still have a first value.

The second is when the dynamic information update according to the first update request succeeded, but the update result was not normally delivered to the server 100, so the server 100 is recording the update status information as a value other than SUCCESS. In this case, the dynamic information of the first terminal 200 will have a second value.

As such, if the update status information of the first terminal 200 is a value other than SUCCESS, the value of the dynamic information received through the first terminal 200 can be both a first value and a second value.

Therefore, in this case, both dynamic information having a first value and dynamic information having a second value are determined to be valid.

Meanwhile, a specific validity verification algorithm for this can be implemented in various ways.

For example, in one embodiment, the server 100 stores both a first reference value corresponding to a first value and a second reference value corresponding to a second value as reference information corresponding to the first terminal 200, and when it is confirmed that the update status information of the first terminal 200 is SUCCESS, the first reference value may be expired or removed.

In this case, if the update status information is SUCCESS, only the second reference value is valid as reference information, so dynamic information having a first value is determined to be invalid.

On the other hand, if the update status information is a value other than SUCCESS, the first reference value is not expired, and both the first reference value and the second reference value are valid as reference information. Therefore, both dynamic information having a first value and dynamic information having a second value can be determined to be valid.

As another example, the server 100 may store a first reference value corresponding to a first value as reference information corresponding to the first terminal 200, and then update the reference information from the first reference value to a second reference value only when the update status information is confirmed to be SUCCESS.

In this case, if the update status information is SUCCESS, the reference information is a second reference value, so dynamic information having a first value is determined to be invalid.

On the other hand, if the update status information is a value other than SUCCESS, the reference information is still a first reference value, so dynamic information having a first value is determined to be valid.

However, in this case, since dynamic information having a second value is determined to be invalid, a validity verification error may occur when the dynamic information update succeeded but the update result was not normally delivered to the server 100, so the update status information is incorrectly recorded as a value other than SUCCESS.

Meanwhile, as a result of validity verification, if the dynamic information is determined to be valid, the server 100 provides internet resource address information corresponding to the dynamic information to the user terminal 300 (S309).

The user terminal 300 accesses the internet resource device 1000 using the provided internet resource address information, and transmits a service request for untact order (S310).

The internet resource device 1000 provides order information and the like in response to the service request, and the user terminal 300 performs untact order by referring to the order information (S311, S312).

The internet resource device 1000 processes the order request of the user terminal 300, and the untact order is completed thereby (S313).

According to the embodiments of the present invention described so far, by periodically or aperiodically updating the dynamic information of the first terminal through interworking with the server to effectively block unauthorized third parties from accessing order information, customers can place untact orders more safely and easily in online/offline stores.

In addition, when the dynamic information of the first terminal is updated, by delivering this to the server so that the dynamic information change information is synchronized with the server in real time, it becomes possible to timely block attempts to access order information using expired dynamic information.

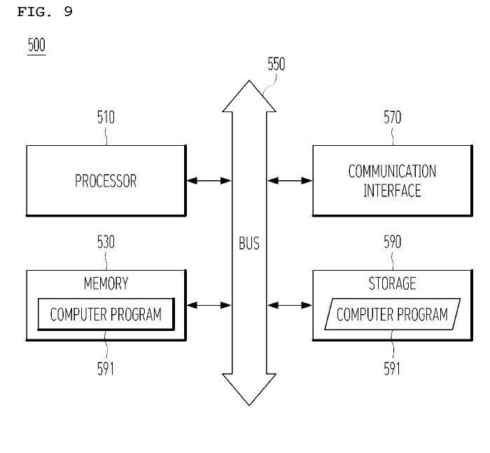

Hereinafter, an exemplary computing apparatus 500 where the methods described in the various exemplary embodiments of the present disclosure are implemented will be described with reference to FIG. 9. For example, the computing apparatus 500 of FIG. 9 may be the server 100, the first terminal 200, or the user terminal 300 of FIG. 1.

FIG. 9 is an exemplary hardware configuration diagram showing a computing apparatus 500.

As shown in FIG. 9, a computing apparatus 500 may include one or more processors 510, a bus 550, a communication interface 570, a memory 530 for loading a computer program 591 executed by the processor 510, and a storage 590 for storing the computer program 591. However, only components related to exemplary embodiments of the present disclosure may be shown in FIG. 9.

Accordingly, it may be understood by those skilled in the art that other general components may be further included in addition to the components shown in FIG. 9.

The processor 510 may control the overall operation of each component of the computing apparatus 500. The processor 510 may be configured to include at least one of a central processing unit (CPU), a microprocessor unit (MPU), a micro controller unit (MCU), a graphics processing unit (GPU), or any type of processor well known in the technical field of the present disclosure. In addition, the processor 510 may perform an operation on at least one application or program for executing a method/operation according to various exemplary embodiments of the present disclosure. The computing apparatus 500 may include one or more processors.

The memory 530 may store various types of data, commands, and/or information. The memory 530 may be capable of loading one or more programs 591 from the storage 590 in order to execute methods/operations according to various exemplary embodiments of the present disclosure. An example of the memory 530 may be RAM, but is not limited thereto.

The bus 550 may provide a communication function between components of the computing apparatus 500. The bus 550 may be implemented as various types of buses such as an address bus, a data bus, and a control bus.

The communication interface 570 may support wired/wireless Internet communication of the computing apparatus 500. The communication interface 570 may support various communication methods other than Internet communication. To this end, the communication interface 570 may be configured to include a communication module well known in the technical field of the present disclosure.

The storage 590 may non-temporarily store one or more computer programs 591. The storage 590 may be configured to include non-volatile memory such as read-only memory (ROM), erasable programmable ROM (EPROM), electrically erasable programmable ROM (EEPROM), flash memory, or the like, a hard disk, a removable disk, or any type of computer-readable recording medium well known in the technical field to which the present disclosure pertains.

The computer program 591 may include one or more instructions where the methods/operations according to various exemplary embodiments of the present disclosure are implemented.

For example, the computer program 591 may include instructions for performing operations of transmitting, at a first update period, a first update request for updating dynamic information of a first terminal; checking update status information of the first terminal; receiving the dynamic information of the first terminal from a user terminal and performing validity verification of the dynamic information; and providing internet resource address information corresponding to the dynamic information to the user terminal if the dynamic information is valid as a result of the validity verification, wherein the first update request is for causing the dynamic information to be updated from a first value to a second value, wherein validity of dynamic information having the first value is determined differently according to the update status information during the validity verification, and wherein the user terminal acquires the dynamic information from the first terminal using a predetermined method and performs untact ordering using the provided internet resource address information.

When the computer program 591 is loaded into the memory 530, the processor 510 may perform methods/operations according to various exemplary embodiments of the present disclosure by executing the one or more instructions.

The technical idea of the present disclosure described so far may be implemented as computer-readable code on a computer-readable medium. The computer-readable recording medium may be, for example, a movable recording medium (CD, DVD, Blu-ray disk, USB storage device, removable hard disk) or a fixed recording medium (ROM, RAM, computer-equipped hard disk). The computer program recorded on the computer-readable recording medium may be transmitted to another computing apparatus through a network such as Internet and may be installed on the other computing apparatus, thereby being used in the other computing apparatus.

Although the exemplary embodiments of the present disclosure have been described with reference to the accompanying drawings, those skilled in the art may understand that the present disclosure may be implemented in other specific forms without changing the technical idea or essential features thereof. Therefore, it should be understood that the exemplary embodiments described above are exemplary and not restrictive in all respects. The scope of protection of the present disclosure should be interpreted by the following claims, and all technical ideas within the equivalent scope should be construed as being included in the scope of the technical idea defined by the present disclosure.

### DESCRIPTIONS FOR REFERENCES

100: server

200: first terminal

300: user terminal

400: relay device

500: computing apparatus

1000: internet resource device

What is claimed is:

1. A method for providing dynamic information for untact orders performed by a server, comprising:
transmitting, at a first update period, a first update request for updating dynamic information of a first terminal;
checking update status information of the first terminal;
receiving the dynamic information of the first terminal from a user terminal and performing validity verification of the dynamic information; and
providing internet resource address information corresponding to the dynamic information to the user terminal if the dynamic information is valid as a result of the validity verification,
wherein the first update request is for causing the dynamic information to be updated from a first value to a second value,
the performing the validity verification differently determines validity of dynamic information having the first value according to the update status information, and
the user terminal acquires the dynamic information from the first terminal using a predetermined method and performs untact ordering using the internet resource address information.

2. The method according to claim 1, wherein the predetermined method includes scanning a screen or image displayed on the first terminal, or communicating with the first terminal in an NFC manner.

3. The method according to claim 1, wherein the performing the validity verification determines dynamic information having the first value as invalid if the update status information is SUCCESS.

4. The method according to claim 1, wherein the performing the validity verification determines dynamic information having the first value as valid if the update status information is a value other than SUCCESS, and
the value other than SUCCESS includes any one of FAIL, PROCESSING, and TIME OUT.

5. The method according to claim 3, wherein the performing the validity verification determines dynamic information having the second value as valid.

6. The method according to claim 1, further comprising:
selectively transmitting, at a second update period, a second update request for updating dynamic information of the first terminal according to the update status information.

7. The method according to claim 6, wherein the selectively transmitting transmits the second update request to the first terminal if the update status information is SUCCESS, and does not transmit the second update request to the first terminal if the update status information is a value other than SUCCESS.

8. A method for providing dynamic information performed by a server, comprising:
(a) transmitting an update request for updating dynamic information based on a predetermined period or event;
(b) receiving update completion information provided by a first terminal after transmitting the update request;
(c) updating reference information stored in the server based on the update completion information;
(d) receiving the dynamic information transmitted through a user terminal, wherein the user terminal acquires the dynamic information by scanning a QR code displayed on the first terminal or communicating with the first terminal in an NFC manner;
(e) verifying validity of the dynamic information by comparing the dynamic information with the reference information; and
(f) providing internet resource address information corresponding to the dynamic information to the user terminal if the dynamic information is valid,
wherein the step (c) comprises:
after receiving the update completion information, determining whether the update of the dynamic information was successful based on the update completion information, and if the update of the dynamic information was successful, expiring the reference information before updating the dynamic information based thereon.

9. The method according to claim 8,
wherein the dynamic information includes at least one of a first URL indicating an address on an internet network of the server, device identification information of the first terminal, and time information.

10. The method according to claim 8, wherein the event includes a update initiation request automatically generated according to a predetermined condition or an update initiation request according to user input.

11. The method according to claim 8, wherein the step (a) comprises transmits change information together with the update request,
the change information includes a QR code image, URL information, or parameter information, and
the first terminal updates the QR code or the dynamic information to have a value corresponding to the change information in response to the update request.

12. The method according to claim 8, wherein the first terminal, in response to the update request, acquires change information by itself according to predetermined logic and updates the QR code or the dynamic information to have a value corresponding to the change information.

13. The method according to claim 8, wherein the update completion information includes the dynamic information updated by the first terminal according to the update request.

14. The method according to claim 8, wherein the server sets a valid time interval corresponding to the reference information, and
the step (e) comprises determining the dynamic information as invalid if it is determined that time information associated with the dynamic information is outside the valid time interval.

15. A server comprising:
a processor;
a memory loading a computer program executed by the processor; and
a storage storing the computer program,
wherein the computer program includes instructions for performing operations of:
transmitting, at a first update period, a first update request for updating dynamic information of a first terminal,
checking update status information of the first terminal,
receiving the dynamic information of the first terminal from a user terminal and performing validity verification of the dynamic information, and
providing internet resource address information corresponding to the dynamic information to the user terminal if the dynamic information is valid as a result of the validity verification,
wherein the first update request is for causing the dynamic information to be updated from a first value to a second value,
during the validity verification, validity of dynamic information having the first value is determined differently according to the update status information, and
the user terminal acquires the dynamic information from the first terminal using a predetermined method and performs untact ordering using the provided internet resource address information.
